(19) United States
(12) Patent Application Publication
(10) Pub. No.: US 2022/0232810 A1
(43) Pub. Date: Jul. 28, 2022

(54) AN AQUACULTURE SYSTEM AND METHODS FOR CIRCULATING AND TREATING FLUID THEREIN

(71) Applicant: Wallenius Water Innovation AB, Stockholm (SE)

(72) Inventors: Mattias ANTONSSON, Vaxholm (SE); Staffan STRAND, Stockholm (SE)

(73) Assignee: Wallenius Water Innovation AB, Stockholm (SE)

(21) Appl. No.: 17/615,258

(22) PCT Filed: Jun. 8, 2020
(86) PCT No.: PCT/SE2020/050578

§ 371 Date: Nov. 30, 2021

(30) Foreign Application Priority Data
Jun. 19, 2019 (SE) 1950755-7

(51) Int. Cl. A01K 63/04; A01K 63/10; A01K 61/59

(52) U.S. Cl. CPC A01K 63/042; A01K 61/59; A01K 63/10

(57) ABSTRACT

An aquaculture system including, at least one grow-out tank; a fluid treatment system including a fluid treatment device, a recirculation pump and fluid connections to each of said at least one grow-out tanks for circulating fluid from each of the at least one grow-out tanks through the fluid treatment device; and at least one fluid delivering device which is connected to the fluid treatment system for delivering said circulated treated fluid to said at least one grow-out tank, which fluid delivering device includes an outlet which can be provided in a position within the at least one grow-out tank such that the treated fluid delivered out from the outlet will be delivered along a bottom of said at least one grow-out tank wherein the outlet of the at least one fluid delivering device is configured such that it can be rotated in order for delivering the fluid in different directions along the bottom of the grow-out tank, wherein the at least one fluid delivering device is configured for delivering the treated fluid to substantially the whole bottom of said at least one tank at a velocity which is enough for resuspending sedimented particles, wherein said fluid treatment system is connected to and is serving said at least one grow-out tank intermittently with time constraints which are based on cultivation conditions for an aquaculture in said at least one grow-out tank.

### TECHNICAL FIELD

The present invention relates to an aquaculture system and to a method for circulating and treating fluid in an aquaculture system.

### BACKGROUND

Two different types of aquaculture systems which are used today are Biofloc Technology, BFT, and Recirculation Aquaculture System, RAS. In a RAS system the water is recirculated via a water treatment system which is not the case in BFT. In an aquaculture system for cultivating shrimps BFT is used, i.e. water is not treated and recirculated in an external water treatment system. This is because shrimps are more sensitive than most types of fishes and they need more time to eat and water which is more still standing than what is optimal for most fishes.

Hereby there may be problems in aquacultures for cultivating shrimps with sedimentation at bottom and thereby the creation of anoxic zones. In Anoxic zones there is a risk that Hydrogen Sulfide is formed and there is an increased growth of harmful bacteria, like for example vibrio. All these are potential risks of death for the cultivated species.

### SUMMARY

An object of the invention is to provide an improved aquaculture system and an improved method for circulating and treating fluid in an aquaculture system.

A further object of the invention is to provide an improved aquaculture system and an improved method for circulating and treating fluid in an aquaculture system which is suitable for cultivation of shrimps.

This is achieved by an aquaculture system and a method for circulating and treating fluid in an aquaculture system according to the independent claims.

According to one aspect of the invention an aquaculture system is provided comprising:
at least one grow-out tank;
a fluid treatment system comprising a fluid treatment device, a recirculation pump and fluid connections to each of said at least one grow-out tanks for circulating fluid from each of the at least one grow-out tanks through the fluid treatment device; and
at least one fluid delivering device provided in each of the at least one grow-out tank, which at least one fluid delivering device is connected to the fluid treatment system for delivering said circulated treated fluid to said at least one grow-out tank, which at least one fluid delivering device comprises an outlet which can be provided in a position within the at least one grow-out tank such that the treated fluid delivered out from the outlet will be delivered along a bottom of said at least one grow-out tank, wherein the outlet of the at least one fluid delivering device is configured such that it can be rotated in order for delivering the fluid in different directions along the bottom of the grow-out tank, wherein the at least one fluid delivering device is configured for delivering the treated fluid to substantially the whole bottom of said at least one tank at a velocity which is enough for resuspending sedimented particles,
wherein said fluid treatment system is connected to and is serving said at least one grow-out tank intermittently with time constraints which are based on cultivation conditions for an aquaculture in said at least one grow-out tank.

According to another aspect of the invention a method for circulating and treating fluid in an aquaculture system comprising at least one grow-out tank is provided. Said method comprises the steps of:
a) transferring a part of a fluid provided in one of the grow-out tanks to a fluid treatment system;
b) treating the fluid in the fluid treatment system;
c) transferring the treated fluid back to the grow-out tank;
d) delivering the treated fluid along a bottom of the grow-out tank, wherein said delivering comprises rotating an outlet of a fluid delivering device provided in the at least one grow-out tank for delivering the treated fluid in different directions along the bottom of the grow-out tank, wherein the at least one fluid delivering device is configured for delivering the treated fluid to substantially the whole bottom of said at least one tank at a velocity which is enough for resuspending sedimented particles;
repeating steps a-d sequentially for each of the grow-out tanks provided in the aquaculture system,
wherein fluid is circulated and treated for each of said at least one grow-out tank intermittently with time constraints which are based on cultivation conditions for an aquaculture in said at least one grow-out tank.

Hereby an aquaculture system is achieved where a recirculation and treatment of the fluid is not provided continuously but only intermittently with time constraints which are based on cultivation conditions for an aquaculture in said at least one grow-out tank. Hereby the species cultured in the grow-out tanks will have some time with still water in between the recirculation which is suitable for some species, for example shrimps. Hereby they will have more time to eat which is suitable for example for shrimps. By adapting the time constraints for when recirculation and treatment of the water should be provided according to cultivation conditions the aquaculture system can be adopted both specifically for different species to be cultured but also for one or more of for example bio mass, grow stage, pH and ammonia-nitrogen level. Hereby an optimized aquaculture system can be provided. Furthermore the bottom of the grow-out tank is effectively cleaned from sedimentation by the recirculated fluid which is delivered along the bottom. The outlet is rotated and hereby the whole bottom of the grow-out tank can be effectively cleaned by the recirculated fluid in an efficient way.

In one embodiment of the invention said aquaculture system is an aquaculture system for cultivating shrimps and wherein said time constraints further are based on eating behavior and metabolism for shrimps.

In one embodiment of the invention said aquaculture system comprises at least two grow-out tanks and said fluid treatment system is connected to and is serving said at least two grow-out tanks sequentially. Hereby one single fluid treatment system can be used for more than one grow-out tank which is effective and cost saving.

In one embodiment of the invention said fluid treatment device comprises at least a nitrification device and a particle removing device.

In one embodiment of the invention said at least one grow-out tank comprises at least one oxygen or air inlet and said aquaculture system comprises an oxygen providing device connected to said at least one oxygen or air inlet for providing oxygen to said at least one grow-out tank separately from said fluid treatment system. Hereby the providing of oxygen to the aquaculture in the grow-out tanks can be separated from the recirculation and treatment of fluid. Hereby oxygenation can, if needed, be continuously or with different periodicity than the recirculation takes place. Hereby the recirculation and treatment of the fluid can be adopted for being optimal for the species grown in the grow-out tank without having to consider oxygenation.

Further embodiments are described in the dependent claims and in the detailed description.

### BRIEF DESCRIPTION OF THE DRAWINGS

FIG. 1 is a schematic drawing of an aquaculture system according to one embodiment of the invention.

FIG. 2a is a schematic side view of a grow-out tank which can be used in an aquaculture system according to one embodiment of the invention.

FIG. 2b is a schematic top view of the same grow-out tank as shown in FIG. 3a.

FIG. 3 is a flow chart of a method according to one embodiment of the invention.

FIG. 4 is a schematic illustration of sequential control of an aquaculture system according to one embodiment of the invention.

### DETAILED DESCRIPTION OF EMBODIMENTS

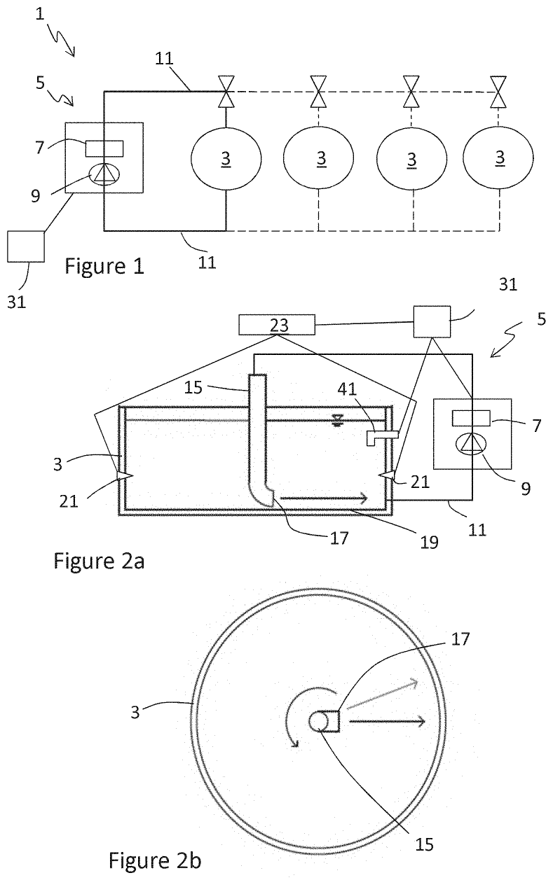

FIG. 1 is a schematic drawing of an aquaculture system 1 according to one embodiment of the invention. The aquaculture system 1 comprises at least one grow-out tank 3. The number of grow-out tanks 3 can vary. For example 1, 2, 3, 4 or 5 grow-out tanks 3 are provided. However also more than five grow-out tanks 3 can be provided. This is shown in FIG. 1 by dotted lines to the second, third and fourth grow-out tanks 3. In the grow-out tanks 3 for example different species of fish or shrimps can be cultivated in water which hereafter is called a fluid.

The aquaculture system 1 comprises furthermore a fluid treatment system 5 which comprises a fluid treatment device 7, a recirculation pump 9 and fluid connections 11 to each of said at least one grow-out tanks 3 for circulating fluid from each of the at least one grow-out tanks 3 through the fluid treatment device 7. Hereby one fluid treatment system 5 can be connected to one or more grow-out tanks 3, i.e. the same fluid treatment system 5 can be used for more than one grow-out tank 3.

The aquaculture system 1 comprises furthermore at least one fluid delivering device 15 which is connected to the fluid treatment system 5 for delivering said circulated treated fluid to said at least one grow-out tank 3. The fluid delivering device 15 can be seen in FIGS. 2a and 2b which are showing a schematic side view and top view of a grow-out tank 3 according to one embodiment of the invention. The fluid delivering device 15 comprises an outlet 17 which can be provided in a position within the at least one grow-out tank 3 such that the treated fluid delivered out from the outlet 17 will be delivered along a bottom 19 of said at least one grow-out tank 3. Hereby the bottom of the grow-out tank is effectively cleaned from sedimentation by the recirculated fluid which is delivered along the bottom.

According to the invention the outlet 17 of the at least one fluid delivering device 15 is configured such that it can be rotated in order for delivering the fluid in different directions along the bottom 19 of the grow-out tank 3. This can be seen in FIG. 2b. The fluid delivering device 15 can be mounted in the grow-out tank 3 such that the outflow of the fluid through the outlet 17 by itself will provide a rotation to the fluid delivering device 15. This could be accomplished by mounting the fluid delivering device 15 on a shaft such that it can rotate around the shaft. Another alternative is to connect the fluid delivering device 15 to a motor for rotating the fluid delivering device. Hereby, by rotating the outlet 17, the whole bottom 19 of the grow-out tank 3 can be effectively cleaned by the recirculated fluid in an efficient way. Some examples of how to provide a pump with a rotating outlet in a tank are disclosed in WO2019/045628.

According to the invention the at least one fluid delivering device is configured for delivering the treated fluid to substantially the whole bottom 19 of said at least one tank at a velocity which is enough for resuspending sedimented particles. A velocity of the flow needed to clean the tank from sedimentation is higher than the velocity of the flow needed for the water treatment. Thanks to the intermittent operation of fluid flow according to the invention, the velocity of the flow will be high enough to accomplish the cleaning of the bottom of the tanks without having to increase the fluid treatment flow (the average flow). There is a critical velocity to resuspend sedimented particles depending on density and size of the particles. In Aquaculture systems such a velocity can be in the range of 5 to 20 cm/s.

According to the invention said fluid treatment system 5 is connected to and is serving said at least one grow-out tank 3 intermittently with time constraints which are based on cultivation conditions for an aquaculture in said at least one grow-out tank 3. Hereby the fluid treatment system 5 will not recirculate and treat fluid from a grow-out tank continuously but instead intermittently, i.e. periodically. Hereby there will be periods in between recirculation periods where the aquaculture in the at least one grow-out tank 3 is more still and calm, i.e. not recirculated. The duration and frequency of these periods, i.e. time constraints, of recirculation and treatment of the fluid will be set dependent on cultivation conditions of the aquaculture provided in the at least one grow-out tank 3. The cultivation conditions can be one or more of for example: type of species, bio mass, grow stage, pH and ammonia-nitrogen level. If more than one grow-out tanks 3 are provided in the aquaculture system 1 the fluid treatment system 5 is connected to and is serving said grow-out tanks sequentially. Furthermore the duration and frequency of the recirculation and treatment periods, i.e. time constraints, can be set independently for each one of the grow-out tanks 3. Hereby the aquaculture system 1 can be optimized for different conditions and the fluid treatment system 5 can be optimally used. For example the different grow-out tanks 3 in the aquaculture system 1 can be treated differently, i.e. the fluid treatment system can be connected to and serve the different grow-out tanks 3 according to different schedules. If for example a grow stage for the cultivated species is different in the different grow-out tanks 3 the need for recirculation and treatment of the fluid may be different.

According to one embodiment of the invention said aquaculture system is an aquaculture system for cultivating shrimps. In this embodiment said time constraints are further based on eating behavior and metabolism for shrimps.

Said fluid treatment device 7 can comprise at least a nitrification device, e.g. a Biofilter and a particle removing device.

The aquaculture system 1 according to the invention comprises suitably one fluid delivering device 15 in each of the grow-out tanks 3. More than one fluid delivering device 15 could also be provided in each grow-out tank 3. Another alternative is that one fluid delivering device 15 can be used for more than one of the grow-out tanks 3, i.e. be moved between the grow-out tanks 3.

In one embodiment of the invention said at least one grow-out tank 3 comprises at least one oxygen inlet 21 and said aquaculture system 1 comprises an oxygen providing device 23 connected to said at least one oxygen or air inlet 21 for providing oxygen to said at least one grow-out tank 3 separately from said fluid treatment system. One or more oxygen or air inlets 21 can be provided in each grow-out tank 3. Hereby the providing of oxygen to the aquaculture in the grow-out tanks can be separated from the recirculation and treatment of fluid. Hereby oxygenation can, if needed, be continuously or with different periodicity than the recirculation takes place. Hereby the recirculation and treatment of the fluid can be adopted for being optimal for the species grown in the grow-out tank without having to consider oxygenation. Typically in Aquaculture the oxygenation need to be continuous.

In some embodiments of the invention the aquaculture system 1 comprises a control system 31 which is connected to the fluid treatment system 5 and configured to control said fluid treatment system 5 to be connected to and serve each of said grow-out tanks 3 in a specific sequence and with specific time constraints in dependence of cultivation conditions for an aquaculture in each grow-out tank. Sensors 41 can be provided in the grow-out tanks 3 for measuring certain cultivation conditions such as pH and ammonia-nitrogen level. The control system 31 can be connected to such sensors 41 and be configured to control the fluid treatment system 5 in dependence of said measured cultivation conditions. The control system 31 can also be connected to the oxygen providing device 23 for controlling the oxygen providing to the grow-out tanks 3.

The operation of the aquaculture system according to the invention can suitably be automated to a high degree.

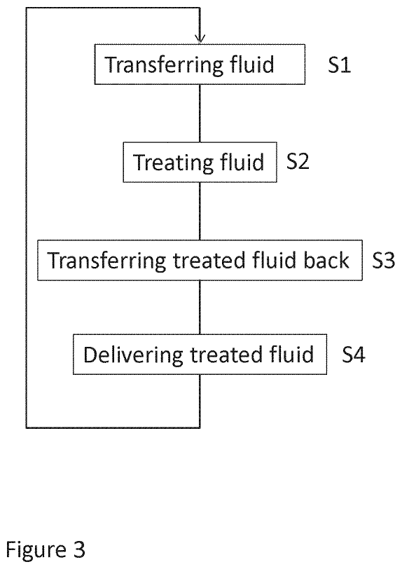

According to the invention a method for circulating and treating fluid in an aquaculture system 1 comprising at least one grow-out tank 3 is also provided. A flow chart of the steps according to the method is shown in FIG. 3. The steps are described in order below:

S1: Transferring a part of a fluid provided in one of the grow-out tanks to a fluid treatment system.
S2: Treating the fluid in the fluid treatment system 5.
S3: Transferring the treated fluid back to the grow-out tank 3.
S4: Delivering the treated fluid along a bottom 19 of the grow-out tank 3. Said delivering comprises rotating an outlet 17 of a fluid delivering device 15 provided in the at least one grow-out tank 3 for delivering the treated fluid in different directions along the bottom 19 of the grow-out tank 3, wherein the at least one fluid delivering device is configured for delivering the treated fluid to substantially the whole bottom 19 of said at least one tank at a velocity which is enough for resuspending sedimented particles.

Repeating steps S1-S4 sequentially for each of the grow-out tanks 3 provided in the aquaculture system 1.

According to the invention fluid is circulated and treated for each of said at least one grow-out tank 3 intermittently with time constraints which are based on cultivation conditions for an aquaculture in said at least one grow-out tank.

In some embodiments of the invention the method further comprises the step of providing oxygen to each grow-out tank 3 separately from the fluid treatment system 1.

In some embodiments of the invention the method further comprises the step of controlling the fluid treatment system 5 by a control system 31 provided in the aquaculture system 1 such that the fluid treatment system 5 is connected to and serves said at least one grow-out tank 3 intermittently with time constraints which are based on cultivation conditions for an aquaculture in said at least one grow-out tank 3.

In some embodiments of the invention the method further comprises the steps of:
measuring cultivation conditions in said at least one grow-out tank 3;
transferring said measured cultivation conditions to the control system 31; and
controlling the fluid treatment system 5 by the control system 31 in dependence of said measured cultivation conditions.

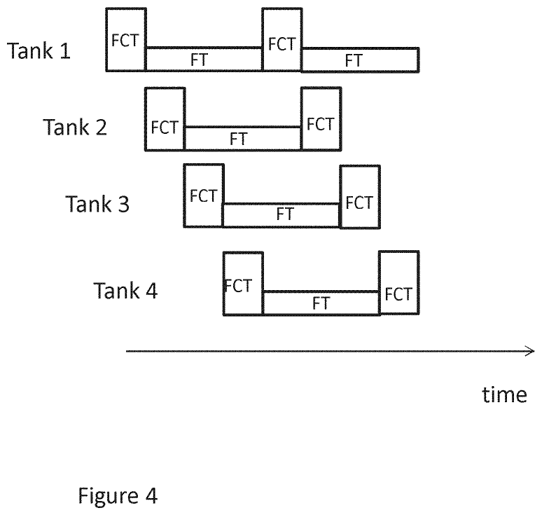

FIG. 4 is a schematic illustration of sequential control of an aquaculture system comprising four grow-out tanks according to one embodiment of the invention. Here it is illustrated how first tank 1 is connected to the fluid treatment system for recirculating and treating the fluid for a specific Fluid Conditioning Time, FCT and then tank 2 is connected to the fluid treatment system and so on coming back to tank 1 after tank 4 has been treated. FP is Feeding Time which will take part in the tanks between the FCT periods. If the fluid conditioning time, FCT, is the same for all four tanks, the feeding time, FP, is thus 3 times FCT. If another number of tanks is used and all tanks are having the same FCT, FT is then equal to: “number of tanks minus one” times FCT. However if different FCT is used for different tanks, which may be wanted when for example different tanks comprise different grow stages of the species, there will be other relations between FP and FCT.

Time constraints can be divided into feeding time and fluid conditioning time that added gives cycle time. By separating Fluid conditioning time (FCT) and Feeding time (FT), the amount of uneaten feed lost, flushed to the water treatment, decreases and the Feed Conversion Ratio, FCR, potentially increases.

Fluid conditioning time (FCT): Elapsed time when water is recirculated in and out from the grow-out tank allowing treated water to maintain good water quality in tank. Depending parameters are listed below, this time can be adjusted.

Feeding time (FT): Elapsed time from when feeding starts to fluid conditioning is initiated, hence the duration time for the species to eat. Minimum feeding time is defined by species eating behaviour and metabolism and targets low FCR. Maximum feeding time is defined by parameters listed below.

General limits and dependencies of sequential cycling:
Time constraints for feeding time (FT) and fluid conditioning time (FCT) is defined by:
   Species eating behaviour and metabolism
   Ammonia-nitrogen (NH3) concentration (<0.05 mg/l) in grow-out tank depending on:
      Total ammonia nitrogen (TAN) concentration, i.e. feeding rate
      pH (range 7-8)
   Water clarity (TSS level 10-100 mg/l depending water depth 1-4 m, turbidity level max 100 NTU)
Time constraints can be met by number of sequential cycles per day
Time constraints can differ between tanks with different biomass and/or different species in respective tank
Sequential mode is preferably automatized to minimize operator labour

1. An aquaculture system comprising:
at least one grow-out tank;
a fluid treatment system comprising a fluid treatment device, a recirculation pump and fluid connections to each of said at least one grow-out tanks for circulating fluid from each of the at least one grow-out tanks through the fluid treatment device; and
at least one fluid delivering device provided in each of the at least one grow-out tank, which at least one fluid delivering device is connected to the fluid treatment system for delivering said circulated treated fluid to said at least one grow-out tank, which at least one fluid delivering device comprises an outlet which can be provided in a position within the at least one grow-out tank such that the treated fluid delivered out from the outlet, will be delivered along a bottom of said at least one grow-out tank, wherein the outlet of the at least one fluid delivering device is configured such that it can be rotated in order for delivering the fluid in different directions along the bottom of the grow-out tank, wherein the at least one fluid delivering device is configured for delivering the treated fluid to substantially the whole bottom of said at least one tank at a velocity which is enough for resuspending sedimented particles,
wherein said fluid treatment system is connected to and is serving said at least one grow-out tank intermittently with time constraints which are based on cultivation conditions for an aquaculture in said at least one grow-out tank.

2. Aquaculture system according to claim 1, wherein said aquaculture system is an aquaculture system for cultivating shrimps and wherein said time constraints further are based on eating behavior and metabolism for shrimps.

3. Aquaculture system according to claim 1, wherein said aquaculture system comprises at least two grow-out tanks and wherein said fluid treatment system is connected to and is serving said at least two grow-out tanks sequentially.

4. Aquaculture system according to claim 1, wherein said fluid treatment device comprises at least a nitrification device and a particle removing device.

5. Aquaculture system according to claim 1, wherein said at least one grow-out tank comprises at least one oxygen or air inlet and said aquaculture system comprises an oxygen providing device connected to said at least one oxygen or air inlet for providing oxygen to said at least one grow-out tank separately from said fluid treatment system.

6. Aquaculture system according to claim 1, further comprising a control system which is connected to the fluid treatment system and configured to control said fluid treatment system to be connected to and serve each of said grow-out tanks in a specific sequence and with specific time constraints in dependence of cultivation conditions for an aquaculture in each grow-out tank.

7. Aquaculture system according to claim 1, wherein said cultivation conditions can be one or more of: type of species, bio mass, grow stage, pH and ammonia-nitrogen level.

8. A method for circulating and treating fluid in an aquaculture system comprising at least one grow-out tank, said method comprising the steps of:
a) transferring (S1) a part of a fluid provided in one of the grow-out tanks to a fluid treatment system;
b) treating (S2) the fluid in the fluid treatment system;
c) transferring (S3) the treated fluid back to the grow-out tank;
d) delivering (S4) the treated fluid along a bottom of the grow-out tank, wherein said delivering comprises rotating an outlet of a fluid delivering device provided in the at least one grow-out tank for delivering the treated fluid in different directions along the bottom of the grow-out tank, wherein the at least one fluid delivering device is configured for delivering the treated fluid to substantially the whole bottom, of said at least one tank at a velocity which is enough for resuspending sedimented particles;
repeating steps a-d sequentially for each of the grow-out tanks provided in the aquaculture system,
wherein fluid is circulated and treated for each of said at least one grow-out tank intermittently with time constraints which are based on cultivation conditions for an aquaculture in said at least one grow-out tank.

9. Method according to claim 8, further comprising the step of:
providing oxygen to each grow-out tank separately from the fluid treatment system.

10. Method according to claim 8, further comprising the step of:
controlling the fluid treatment system by a control system provided in the aquaculture system such that the fluid treatment system is connected to and serves said at least one grow-out tank intermittently with time constraints which are based on cultivation conditions for an aquaculture in said at least one grow-out tank.

11. Method according to claim 10, further comprising the steps of:
measuring cultivation conditions in said at least one grow-out tank;
transferring said measured cultivation conditions to the control system; and
controlling the fluid treatment system by the control system in dependence of said measured cultivation conditions.

12. A method for circulating and treating a fluid in an aquaculture system according to claim 1, wherein said method comprises connecting said fluid treatment system to said at least one grow-out tank, for circulating and treating a fluid in the grow-out tanks intermittently with time constraints which are based on cultivation conditions for an aquaculture in said at least one grow-out tank.
